(19) United States
(12) Patent Application Publication
(10) Pub. No.: US 2009/0129926 A1
(43) Pub. Date: May 21, 2009

(54) MASS POD TURBINE SYSTEM

(76) Inventor: Richard L. Smith, Madison, MS (US)

Correspondence Address: ATTN: E.J. ASBURY III;TAYLOR BUSCH, LLP, 1600 PARKWOOD CIRCLE, SUITE 200, ATLANTA, GA, 30339, US

(21) Appl. No.: 12/206,714

(22) Filed: Sep. 8, 2008

Related U.S. Application Data
(60) Provisional application No. 60/970,262, filed on Sep. 6, 2007.

(51) Int. Cl. F01D 5/00

(52) U.S. Cl. 416/145

(57) ABSTRACT

A mass pod turbine device includes a rotating element configured to rotate about a shaft axis. A plurality of mass pods restrained about the periphery of the rotating element. The mass pods are restrained to the rotating element, but may be displaced relative to the center of rotation. During a rotational cycle of the rotating element, the mass center of each mass pod may be dynamically displaced relative to the center of rotation. The mass pods then generating a mass imbalance about the rotational axis and causing the device to rotate about the shaft axis. The system also provides a useful variable inertia member for the storing of the kinetic energy of a rotating assembly.

### CROSS-REFERENCE TO RELATED APPLICATION

This application claims the benefit of U.S. Provisional Application Ser. No. 60/970,262, filed on Sep. 6, 2007, the entirety of which is hereby incorporated herein by reference.

### BACKGROUND OF THE INVENTION

1. Field of the Invention

The present invention generally relates to mechanical rotational power conversion and generation. More particularly, the present invention relates to the use of a plurality of rotating masses, whose distance from the center of rotation may be dynamically varied, to generate rotation of the assembly in a gravity field. The system and device also provides a useful variable inertial member in the storing and management of the kinetic energy of any rotating assembly.

2. Description of the Related Art

The use of imbalanced weight to drive a rotating element has been employed for centuries. The water wheel of ancient mills relied on the principal of water filling the buckets of one segment of the wheel, and this making the wheel imbalanced or heavier on on the water side. The weight of the water forces the wheel to rotate until the water was dumped from the buckets at the bottom of the rotation. As the wheel rotates, new buckets are filled from a water source, and the process repeats.

The example above is a primitive turbine used to harness the potential energy due to gravity contained in the falling water source. Potential energy may be defined as the ability to do work. In this example, the each bucket of water is able to provide a force in a downward direction about the rotational axis of the shaft, and for a distance around the periphery of the water wheel. One definition of work is to supply a force over a given distance.

Often certain positions are termed as reference position, or reference state, and the work is calculated verses this position. The work available from the action of a gravitational force on an object is often called gravitational potential energy. As may be appreciated by those skilled in the art, means to convert one form of energy into other forms of energy have long been utilized. If the desired final energy form is rotational kinetic energy, the energy conversion means is often complex and cumbersome.

Accordingly, what is needed in the art is a ready means to convert various forms of energy into rotational kinetic energy efficiently and with a minimal of mechanical complexity. The system should also provide for the storage of rotational kinetic energy in useful forms, such as at a preferred speed. It is to such a system for generating and stroring rotational kinetic energy that the present invention is directed.

### SUMMARY OF THE INVENTION

The disadvantages of the prior art are overcome by the present invention which, in one aspect, is a mass pod turbine device, the device includes a rotating element configured to rotate about a shaft axis and having a rotational velocity. A plurality of mass pods restrained about the periphery of the rotating element, each mass pod having a mass center. The mass pods are restrained to the rotating element, but may be displaced relative to the rotating element. And during a rotational cycle of the rotating element, the mass center of each mass pod may be displaced relative to the rotating element. Each mass center of each mass pod has a gravity moment arm about the shaft axis. The rotational cycle has a falling portion and an elevating portion for each mass pod. During a rotational cycle, the gravity moment arm of the mass center of each mass pod is greater on the falling portion of the rotational cycle than on the elevating portion of the rotational cycle. A positive torque is then generated on the rotating element about the shaft axis.

In another aspect of the present invention, the plurality of mass pods may include an odd or even number of mass pods. The displacement of the mass pods relative to the rotating element may be a rotation of the mass pod about an axis, or may be a translation of the mass pod along some path. The displacement of the mass pods relative to the rotating element may be controlled electrically, electro-mechanically, hydraulically, or by other means as are known to those skilled in the art.

In yet another aspect of the present invention, each mass center of each mass pod has a radius from the shaft axis. As the radius from the shaft axis of the mass center of each mass pod is increased, the rotational inertial of the mass pod turbine device assembly is increased. As the radius from the shaft axis of the mass center of each mass pod is decreased, the rotational inertial of the mass pod turbine device assembly is decreased.

In yet another aspect, the present invention provides a variable inertia system, the device having a rotating element configured to rotate about a shaft axis and having a rotational velocity. A plurality of mass pods are restrained about the periphery of the rotating element, each mass pod having a mass center. The mass pods are restrained to the rotating element, but may be displaced relative to the rotating element. During a rotational cycle of the rotating element, the mass center of each mass pod may be displaced relative to the rotating element. Each mass center of each mass pod has a radius from the shaft axis. As the radius from the shaft axis to the mass center of each mass pod is increased, the rotational inertial of the variable inertial device is increased.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE DRAWINGS

FIG. 1 is a perspective view of a prior art power generation system.

FIG. 2 is a front view of an embodiment of the present invention using 3 mass pods.

FIG. 3 is a front view of the embodiment of FIG. 2 showing the mass pods dynamically displaced.

FIG. 4 is a front view of another embodiment of the present invention using 4 mass pods.

FIG. 5 is a front view of another embodiment of the present invention using 5 mass pods.

FIG. 6 is a front view of the embodiment of FIG. 5 showing the mass pods dynamically displaced to form a mass imbalance.

FIG. 7 is a front view of another embodiment of the present invention using 5 mass pods as a variable inertial member.

FIG. 8 is a front view of the embodiment of FIG. 7 showing the mass pods partially extended.

FIG. 9 is a front view of the embodiment of FIG. 7 showing the mass pods fully extended.

### DETAILED DESCRIPTION OF THE INVENTION

The invention presents a mass pod turbine system. The system provides an innovative alternative to traditional power conversion and generation means. The mass pod turbine system can replace traditional turbine systems to drive generator systems for electricity production. The system may also be employed to provide a variable inertial member in a traditional turbine system. The system also provides a useful variable inertia member in the storing of the kinetic energy of any rotating assembly. By employing the mass pod turbine, the speed of rotation of an assembly may be altered to a more preferred value for a given task, without losing or destroying the stored kinetic energy represented in the rotating assembly. The variable inertial member may be used to accelerate or decelerate the turbine as required, while still conserving the rotational kinetic energy of the rotating system.

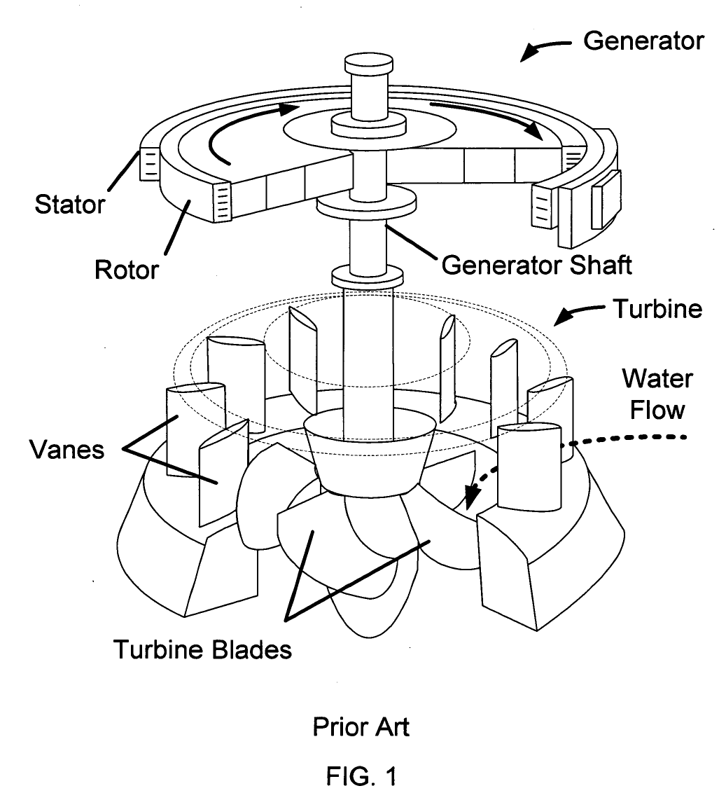

The driving force for the Mass Pod Turbine System is rotational kinetic energy determined by the combined affect of multiple rotating mass pods. The combined affect of multiple rotating masses is advantageous when compared against a single mass or a lesser number of masses. The mass pods may replace the turbines of common prior art turbine systems as depicted in FIG. 1. In prior art turbine systems as depicted in FIG. 1, a water flow impinges on the blades of a turbine. The turbine is connected to a generator via a rotation shaft. The rotation turbine and shaft spin the generator rotor and produce electric current. In the present invention, a mass pod turbine may replace the turbine of the prior art.

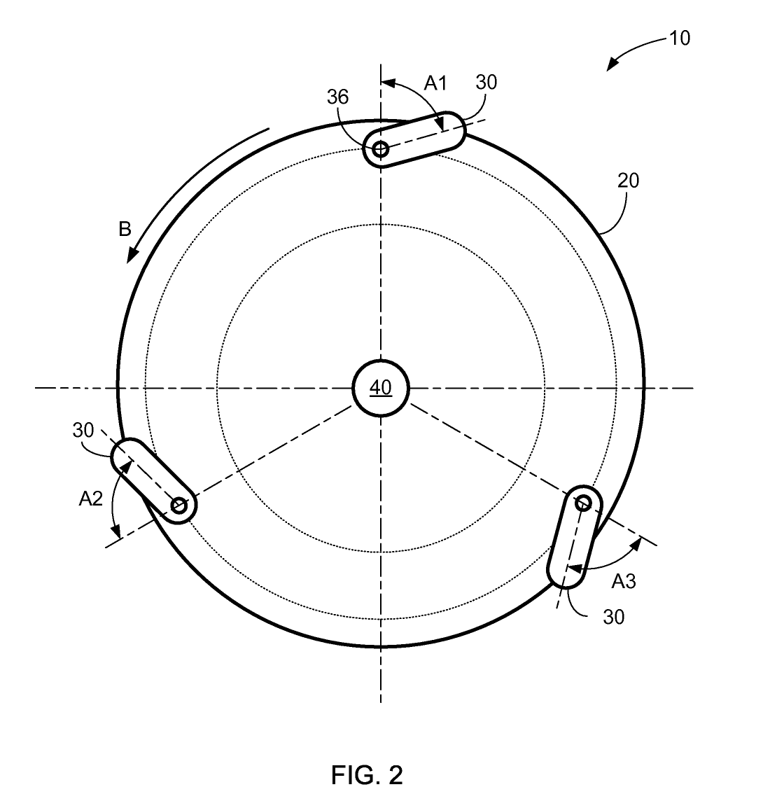

Turning now to the figures and drawings, where like numeral represent like elements throughout, FIG. 2 depicts a first embodiment of the present invention. As depicted in FIG. 2, a rotating mass pod turbine assembly 10 has three mass pods 30. The mass pod turbine 10 is configured to rotate on shaft 40 in the direction of Arrow B. The rotating element has a base 20 onto which mass pods 30 are hinged at location 36. The mass pods 30 may rotate about the hinged connection 36 relative to the base 20. The angle of each mass pod 30 is depicted relative to a radial vector drawn from the center of rotation at shaft 40 to the mass pod hinge location at 36. The angles of the 3 pods are denoted as A1, A2, and A3 respectively. As depicted in FIG. 2, the angles of each mass pod are equal and the rotating assembly 10 is balanced about the shaft 40.

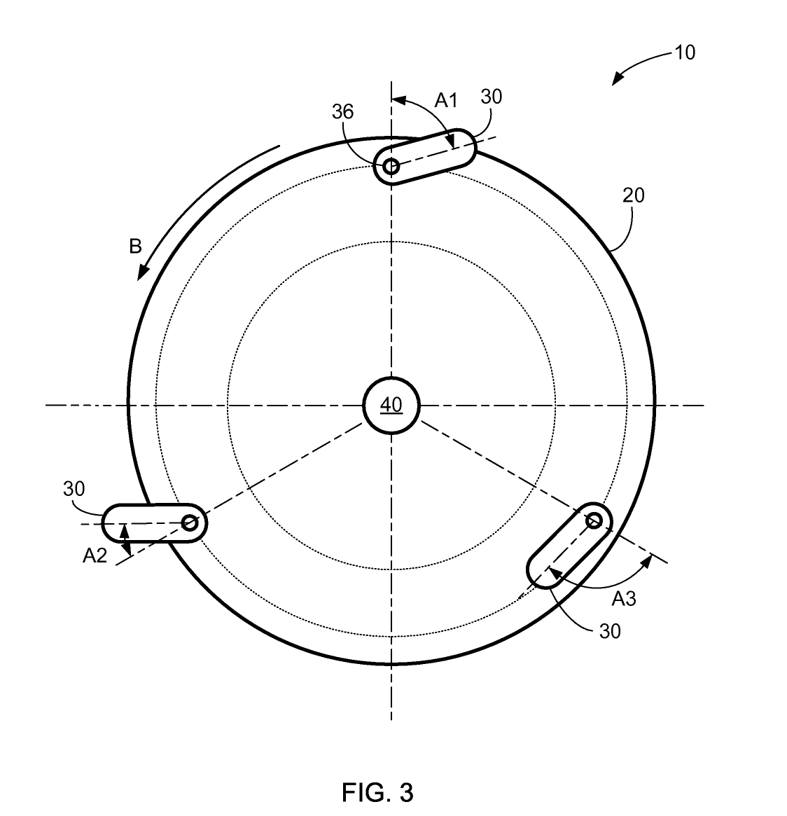

As depicted in FIG. 3, the angle of each mass pod may be dynamically varied during the rotation of the assembly 10. In FIG. 3, the angle A2 of the second mass pod has been reduced relative to first mass pod at A1. This forces the center of mass of the second mass pod, and as used herein the center of gravity, farther to the left from the center of rotation at shaft 40. The angle A3 of the third mass pod has been increased relative to the first mass pod at A1. This results in the center of mass of the third mass pod farther to the left from the center of rotation at shaft 40. In this rotational position, the displacement of second and third mass pods forces the center of mass of the rotating assembly 10 to the left of shaft 40. In a constant gravitational field, the displacement of the center of mass will cause a torque to be exerted upon the rotation assembly 10 equal to the product of the combined mass of three mass pods multiplied by the moment arm of the mass imbalance. The torque generated by the mass imbalance will vary as the mass pods rotate about the center of rotation 40. As the assembly 10 rotates, the angle A1, A2, and A3 of each mass pod 30 is dynamically varied to create the desired mass imbalance about the shaft 40. Stated another way, a constant imbalance of weight on the downward rotating side of the assembly produces a torque on the turbine in a counter clockwise direction. All of this combines to force the turbine to continue thru a cyclic rotation. As the assembly rotates, the angles of each mass pod are adjusted to maintain the weight imbalance. When a braking action of the rotating assembly 10 is desired, the angle of each pod may be varied to create a torque opposing the rotation of the assembly.

In a another embodiment of the present invention, the angular position of each mass pod unit 30 is controlled by a computer microprocessor which individually controls the extension/retraction angle of each pod 30 unit by an efficient electric servo motor at the appropriate time during the rotational cycle of the assembly 10. The angle of each pod may be controlled by an embedded or an external computer such as a P.C. or a Programmable Logic Control (PLC) or other processing means as are readily known to those skilled in the art.

The rotational position of the assembly 10, and the extension angle of the mass pods 30, can be monitored by the processor using any combination of input devices such as photo sensors, proximity sensors, encoders, or other means as are readily known to those skilled in the art. Based upon the rotational position of the assembly, the processor will dynamically retract and extend the mass pods during rotation. The processor can also be used to track the rotational velocity of the device and may adjust and combination of the rotational velocity, or the power output of the device on an as needed basis. The ability to modulate the available power from the device further conserves the energy required to drive the mass pods. The reaction time of each mass pod element, and each monitoring element, is of considerable importance in enabling the processor to have real time, dynamic control of the assembly and for the device to function at the greatest level of efficiency. At higher rotational speeds, the extension and retraction of the mass pods may continuously vary using pre-calculated values over the rotational positions. The amplitude of the extension and retraction range may then be varied in real time to control the speed and power output of the system.

As will be appreciated by those skilled in the art, the dimensions of the turbine and weight of the mass pods can be adjusted as required for a given application. In one example, a 6 inch diameter turbine wheel with weighted masses of 10 ounces are applied. In another example, a 30 foot diameter turbine with mass pods of several tons may be utilized depending upon the power requirements and other parameters of the drive system. The extension and retraction of each mass pod during the rotational cycle of the assembly may be done electronically via a servo motor, or by other means such as electromechanically using an electric motor with a screw actuator, an electric motor with reduction gears, hydraulically, a linear actuator, or by other means as are readily known to those skilled in the art. In one embodiment of the present invention, the mass pods are hinged to the rotating assembly 10 and may rotate relative to the base 20. In alternative embodiments of the present invention, the mass pods may be restrained to move linearly or curve-linearly upon the rotating base 20.

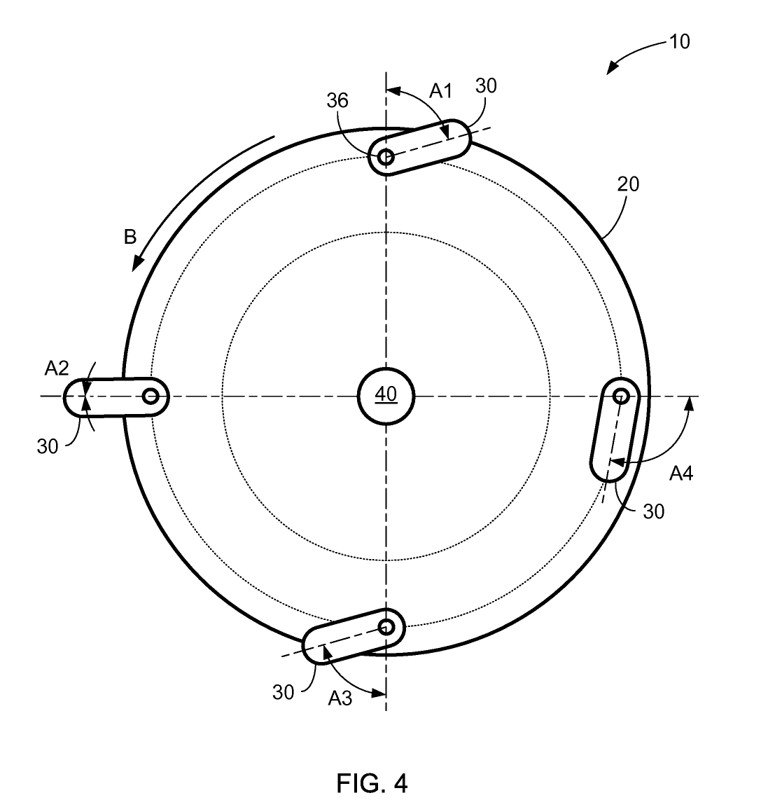

FIG. 4 depicts another embodiment of the present invention. As depicted in FIG. 4, a rotating mass pod turbine assembly 10 has four mass pods 30. The mass pod turbine 10 is configured to rotate on shaft 40 in the direction of Arrow B. The rotating assembly 10 has a base 20 onto which mass pods 30 are hinged at locations 36. As in the embodiment of FIG. 2, the angles of the four pods are denoted as A1, A2, A3 and A4 respectively.

As in the embodiment of FIG. 2, the angle of each mass pod 30 may be dynamically varied during the rotation of the assembly 10. In FIG. 4, the angle A2 of the second mass pod has been reduced relative to first mass pod at A1 such that the moment arm of the second mass pod is a maximum valued from the center of rotation at 40. The angle A3 of the third mass pod is equal to the angle A1 of the first mass pod 30. The angle A4 of the fourth mass pod has been increased to minimize the moment arm. As depicted in this rotational position, the displacement of second and fourth mass pods forces the center of mass of the rotating assembly 10 to the left of shaft 40. Stated another way, due to the unequal moment arms, gravity acting upon the second mass pod on the falling side of the assembly will produce a greater torque than that required to lift the fourth mass pod rising on the opposing side of the assembly. The torque generated by the mass imbalance will then cause the assembly to rotate. In the rotational position depicted in FIG. 4, the gravity moment arms of mass pods one and three are equal and opposite.

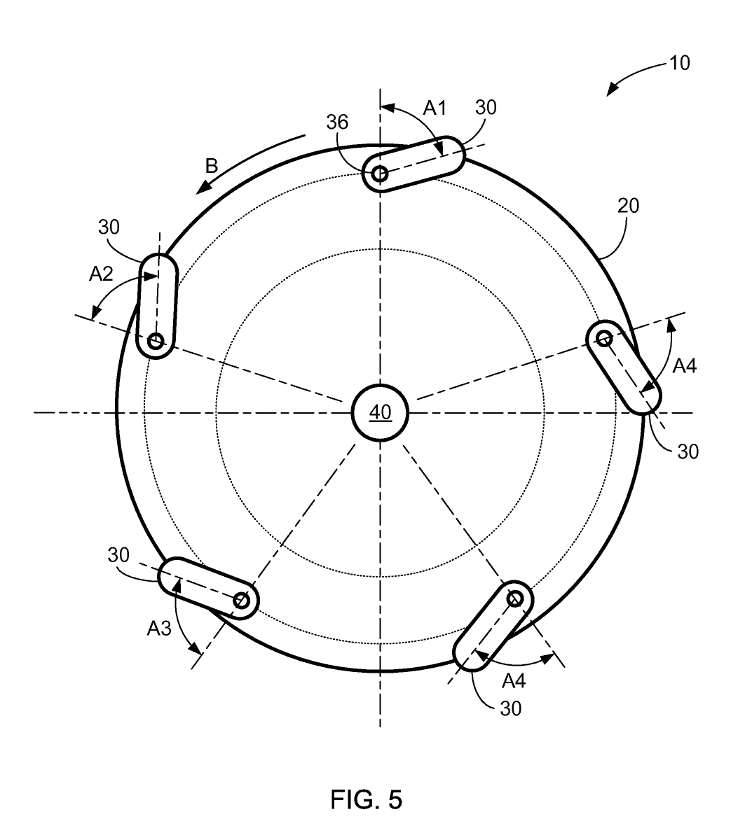

FIG. 5 depicts another embodiment of the present invention using five mass pods 30. As in the prior embodiment of FIG. 2, the angles of the five pods are denoted as A1, A2, A3, A4 and A5 respectively. As depicted in FIG. 5, the angles of each mass pod 30 are equal and the rotating assembly 10 is balanced about the shaft 40.

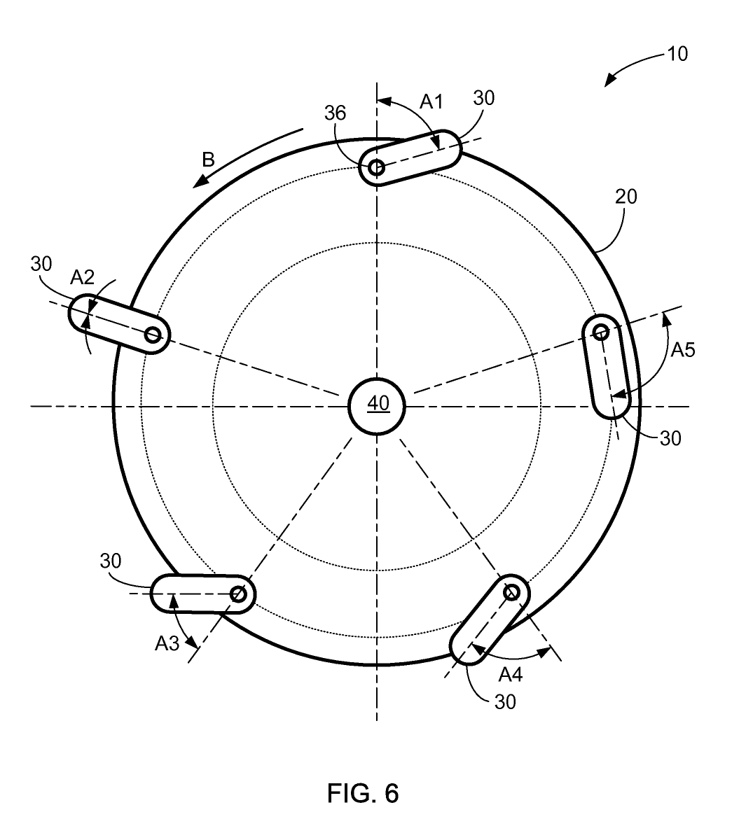

As depicted in FIG. 6, the angle of each mass pod is dynamically varied during the rotation of the assembly 10. In FIG. 6, the angles A2 and A3 of the second and third mass pods have been reduced relative to first mass pod at A1. The angles A4 and A5 of the fourth and fifth mass pods have been increased relative to the first mass pod at A1. As in the previous examples, this configuration results in the center of mass of all mass pods to be on the downward or falling side of the rotating assembly 10. The distance from the combined center of mass to the center of rotation, or total moment arm, determines the magnitude of the torque exerted at this instant in time upon rotating assembly by the combined weight of the mass pods. As will be appreciated by those skilled in the art, multiple mass pods spaced equally about the periphery of the rotating assembly will result in a continuous generation torque upon the rotating assembly. The number of mass pod assemblies utilized may be varied based upon the desired operating parameters and other design criteria.

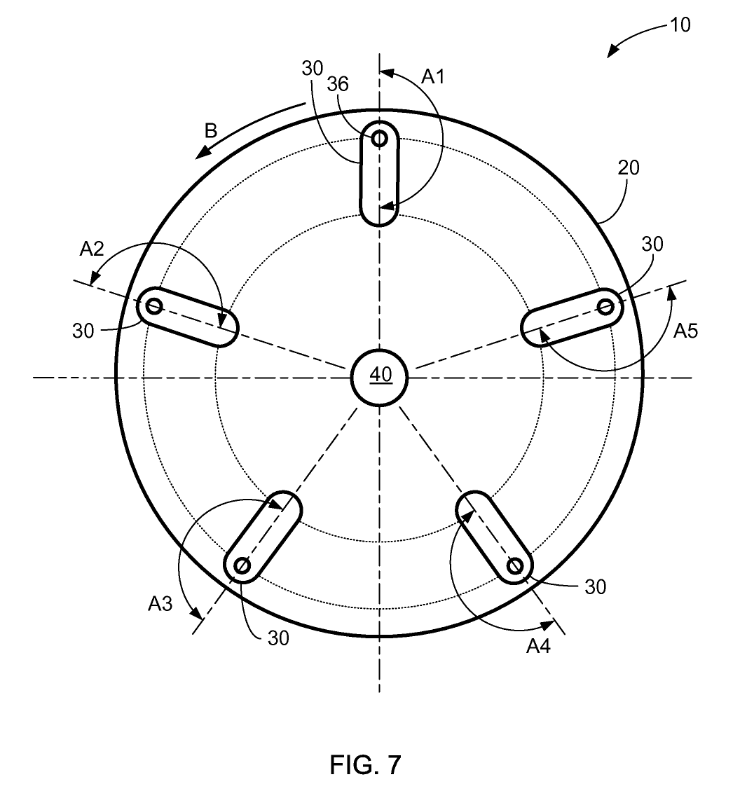

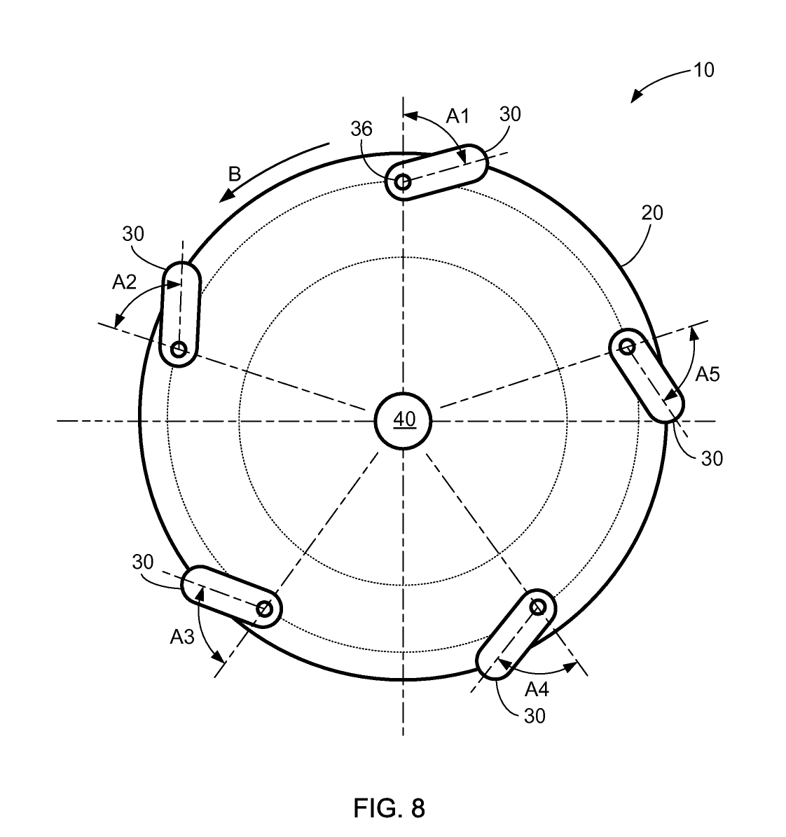

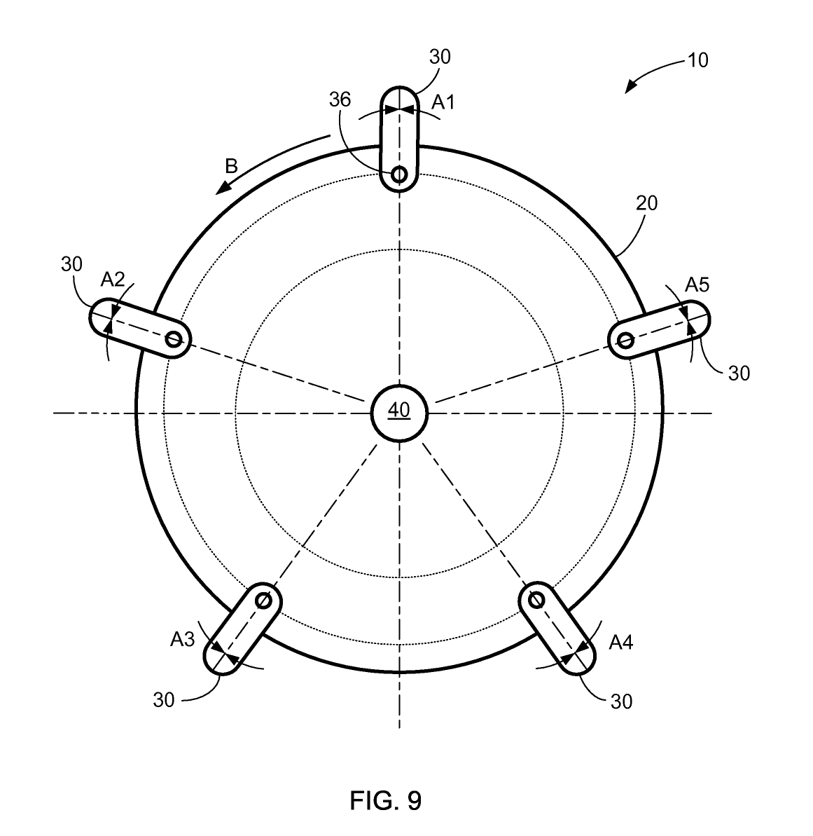

Another alternative embodiment of the present invention in presented in FIG. 7. In this embodiment, the mass pod turbine system is used as a variable inertial element within the rotating assembly. As depicted in FIG. 7, each mass pod 30 is rotated inward to product the smallest inertia about the center of rotation 40. In this configuration, the mass pod is easy to rotationally accelerate and stores the least rotational energy at any given rotational speed. FIG. 8 depicts each mass pod 30 being rotated outward dynamically to increase the inertial of the rotating assembly. FIG. 9 depicts the assembly at the maximum rotational inertia with each mass pod 30 fully extended from the center of rotation.

Using this methodology, the speed of a rotating assembly may remain constant, while the energy stored within the rotating assembly may increase or decrease. In the case of a varying or fluctuating torque applied to a rotating assembly, the inertial of the assembly may be dynamically adjusted during operation to provide a more constant rotational speed of the assembly. In this embodiment, the extension angle of all mass pods 30 are equal at any rotational position or time, but the extension angle of all pods may vary to increase or decrease the inertial of the rotating assembly as required.

The variable inertial member provided by the mass pod may also be used to accelerate or decelerate the rotating assembly as required, while still conserving the rotational kinetic energy of the system. By extending or retracting the mass pods equally, the inertial of the rotating assembly may be decreased to increase the rotational speed, or increased to slow the rotational speed. By employing the mass pod turbine, the speed of rotation of an assembly may be altered to a more preferred value for a given task, without losing or destroying the stored kinetic energy represented in the rotating assembly. A change in the rotational speed of an assembly may be useful for the meshing of gears, to match the output or speed of a companion system, or for other uses as are readily known to those skilled in the art.

All of the systems and methodologies disclosed and claimed herein can be made and executed without undue experimentation in light of the present disclosure. While the system and process of this invention have been described in terms of preferred embodiments, it will be apparent to those of skill in the art that variations may be applied to the systems, and process, and in the steps, or in the sequence of steps, of the methods described herein without departing from the concept, spirit, and scope of the invention. All such similar substitutes and modifications apparent to those skilled in the art are deemed to be within the spirit, scope, and concept of the invention.

I claim:

1. A mass pod turbine device, the device comprising:
a rotating element, the rotating element configured to rotate about a shaft axis and having a rotational velocity;
a plurality of mass pods restrained about the periphery of the rotating element, each mass pod having a mass center;
wherein the mass pods are restrained to the rotating element, but may be displaced relative to the rotating element; and
wherein during a rotational cycle of the rotating element, the mass center of each mass pod may be displaced relative to the rotating element.

2. The device of claim 1, wherein the plurality of mass pods comprises an odd number of mass pods.

3. The device of claim 1, wherein the plurality of mass pods comprises an even number of mass pods.

4. The device of claim 1, wherein the displacement of the mass pods relative to the rotating element is a rotation of the mass pod about an axis.

5. The device of claim 1, wherein the displacement of the mass pods relative to the rotating element is a translation of the mass pod along a path.

6. The device of claim 1, wherein the displacement of the mass pods relative to the rotating element is controlled electrically.

7. The device of claim 1, wherein the displacement of the mass pods relative to the rotating element is controlled hydraulically.

8. The device of claim 1, wherein the displacement of the mass pods relative to the rotating element is controlled electro-mechanically.

9. The device of claim 1, further comprising;
each mass center of each mass pod having a gravity moment arm about the shaft axis, and the rotational cycle having a falling portion and an elevating portion for each mass pod; and
wherein during a rotational cycle, the gravity moment arm of the mass center of each mass pod is greater on the falling portion of the rotational cycle than on the elevating portion of the rotational cycle, thereby generating a positive torque on the rotating element about the shaft axis.

10. The device of claim 1, further comprising;
each mass center of each mass pod having a radius from the shaft axis; and
wherein as the radius from the shaft axis of the mass center of each mass pod is increased, the rotational inertial of the mass pod turbine device assembly is increased.

11. The device of claim 1, further comprising;
each mass center of each mass pod having a radius from the shaft axis; and
wherein as the radius from the shaft axis of the mass center of each mass pod is decreased, the rotational inertial of the mass pod turbine device assembly is decreased.

12. A mass pod turbine device, the device comprising:
a rotating element, the rotating element configured to rotate about a shaft axis and having a rotational velocity;
a plurality of mass pods restrained about the periphery of the rotating element, each mass pod having a mass center;
wherein the mass pods are restrained to the rotating element, but may be displaced relative to the rotating element;
wherein during a rotational cycle of the rotating element, the mass center of each mass pod may be displaced relative to the rotating element;
wherein each mass center of each mass pod having a gravity moment arm about the shaft axis, and the rotational cycle having a falling portion and an elevating portion for each mass pod; and
wherein during a rotational cycle, the gravity moment arm of the mass center of each mass pod is greater on the falling portion of the rotational cycle than on the elevating portion of the rotational cycle, thereby generating a positive torque on the rotating element about the shaft axis.

13. A variable inertia device, the device comprising:
a rotating element, the rotating element configured to rotate about a shaft axis and having a rotational velocity;
a plurality of mass pods restrained about the periphery of the rotating element, each mass pod having a mass center;
wherein the mass pods are restrained to the rotating element, but may be displaced relative to the rotating element;
wherein during a rotational cycle of the rotating element, the mass center of each mass pod may be displaced relative to the rotating element;
each mass center of each mass pod having a radius from the shaft axis; and
wherein as the radius from the shaft axis of the mass center to each mass pod is increased, the rotational inertial of the variable inertial device is increased.
